(19) United States
(12) Patent Application Publication
(10) Pub. No.: US 2012/0088619 A1
(43) Pub. Date: Apr. 12, 2012

(54) CHAIN PLATE HAVING INCREASED PRESS OUT FORCE AND METHOD FOR MAKING SAME

(75) Inventors: Horst Adel, Grafensteinberg (DE); Troy Luck, Cheraw, SC (US)

(73) Assignee: SCHAEFFLER TECHNOLOGIES GMBH & CO. KG, Herzogenaurach (DE)

(21) Appl. No.: 13/268,036

(22) Filed: Oct. 7, 2011

Related U.S. Application Data
(60) Provisional application No. 61/390,801, filed on Oct. 7, 2010.

(51) Int. Cl. F16G 13/06; B21L 9/02; F16G 15/12

(52) U.S. Cl. 474/228; 474/206; 59/8

(57) ABSTRACT

An outer plate for a chain is disclosed, the outer plate having two bores each adapted to receive an end of a pin. Each one of the bores has an inner wall with a layer of imbedded abrasive material. A chain assembled from the outer plates and the pins is also provided.

### CROSS REFERENCE TO RELATED APPLICATION

This application claims the benefit of U.S. Provisional Application Ser. No. 61/390,801, filed Oct. 7, 2010, which is incorporated by reference as if fully set forth herein.

### FIELD OF INVENTION

This application is generally related to chains and more particularly related to the outer plates of chains.

### BACKGROUND

Chains and chain drive systems are widely used in various mechanical applications, including the automotive field. A typical chain drive uses a chain to transmit power from a driving gear to a driven gear. Drive chains such as roller chains and silent chains, also known as inverted toothed chains, are generally constructed using only plates and pins. As the chain passes over a gear, the teeth of the gear interact with the openings between the links of the chain or teeth formed on the links of the chain. A typical roller chain or silent chain is held together solely by a press-fit between the outermost plates and the pins, with the inner plates acting as articulating links. Such roller chains and silent chains are usually formed through a continuous operation. First, a top outer plate having two bores is press-fitted onto the top ends of two pins. Next, two top inner plates, each having two bores, are each arranged around one of the two pins with a slip-fit so that each top inner plate is offset from the top outer plate by one pin. A middle plate having two bores is then arranged around the two pins with a press-fit or a slip-fit, the middle plate being aligned with the top outer plate. Two bottom inner plates, each having two bores, are also each arranged around one of the two pins with a slip-fit such that the two bottom inner plates are aligned with the two top inner plates. Finally, a bottom outer plate having two bores is press-fitted onto the bottom ends of the two pins to form one link of the chain.

Since the only press-fit holding each link of the chain together is between the top and bottom outer plates and the pins, it is desirable to increase the minimum amount of force required to remove the outer plates from the pins. This force is also known as the press out force, which is generally a function of the load-carrying contact area between the bores of the outer plates and the pins. One way of increasing the press out force is by increasing the thickness of the outer plates, which results in longer bores with larger contact areas. However, doing so also increases the size, weight, and cost of the chain. Another method of increasing the press out force is by using a shaving or fine blanking operation to form the bores in the outer plates instead of regular blanking. During a regular blanking operation, the bores are formed through a single punching process. However, the shear forces of punching result in a breakout area that is larger than the desired size of the bore. The breakout area decreases the load-carrying contact area of the bores and does not contribute to the press-fit between the outer plates and the pins. To reduce this breakout area, a shaving operation can be used. The bores are first formed through a regular blanking process using a smaller diameter punch, then the bores are shaved by using a second punch to remove a small amount of material. This reduces the breakout area and obtains better dimensional accuracy, but requires an additional step and thus increases the time and cost of construction. To further reduce the breakout area and increase the press out force, a fine blanking operation can be used instead of regular blanking or regular blanking and shaving. During fine blanking, the breakout area is minimized by compressing the outer plate and using an upper and lower punch to form the bore in a process that is more like extrusion than typical punching. While fine blanking increases the load-carrying contact area of the bores, it is expensive, time consuming, and requires special equipment. Therefore, a need exists for a chain that has an outer plate with reduced thickness and increased press out force, but is simple and inexpensive to construct

### SUMMARY

An outer plate for a chain is disclosed, the outer plate having two bores each adapted to receive an end of a pin. Each bore has an inner wall with a layer of imbedded abrasive material. In other embodiments of the outer plate, the abrasive material can be aluminum oxide or silicon oxide. In addition, each of the bores can have a diameter of approximately 4 mm and the outer plate can have a thickness of less than 1.3 mm.

A chain is also disclosed having pins, each having a first end and a second end, and first and second outer plates press-fitted around the first and second ends of each of the pins, respectively. Each of the first outer plates has two bores through which the first ends of respective ones of the pins extend, and each of the second outer plates has two bores through which the second ends of respective ones of the pins extend. Each of the bores of the first and second outer plates has an inner wall with a layer of imbedded abrasive material. The chain further includes inner plates disposed between the first and second outer plates, each of the inner plates having two bores arranged around respective ones of the pins with a slip fit. In other embodiments of the chain, the inner plates can include first and second inner plates and middle plates disposed between the first and second inner plates. The first and second outer plates are aligned with the middle plates, and the first and second inner plates are aligned with each other and offset by one pin from the middle plates. The abrasive material can be aluminum oxide or silicon oxide.

A method of forming an outer plate for a chain is also disclosed. The method includes the steps of providing a plate, forming two bores in the plate through blanking, and forming a layer of embedded abrasive material in an inner wall of each bore, preferably by tumbling the plate with a solution containing the abrasive material and a tumbling media. For sake of brevity, this summary does not list all aspects of the present invention, which is described in further detail below.

### BRIEF DESCRIPTION OF THE DRAWINGS

The foregoing summary, as well as the following detailed description of the preferred embodiments of the invention will be better understood when read in conjunction with the appended drawings. For the purpose of illustrating the invention, there is shown in the drawings embodiments which are presently preferred. It should be understood, however, that the invention is not limited to the precise arrangement shown.

FIG. 1 is a perspective view of a chain having an embodiment of the outer plate of the current invention.

FIG. 2 is a fragmentary cross-sectional view of the chain shown in FIG. 1.

FIG. 3 is a microscopic view of a representative portion of the bore in the outer plate of the current invention.

### DETAILED DESCRIPTION OF THE PREFERRED EMBODIMENTS

Certain terminology is used in the following description for convenience only and is not limiting. The words “inner,” “outer,” “top,” and “bottom” designate directions in the drawings to which reference is made. A reference to a list of items that are cited as “at least one of a, b, or c” (where a, b, and c represent the items being listed) means any single one of the items a, b, or c, or combinations thereof. The terminology includes the words specifically noted above, derivatives thereof, and words of similar import.

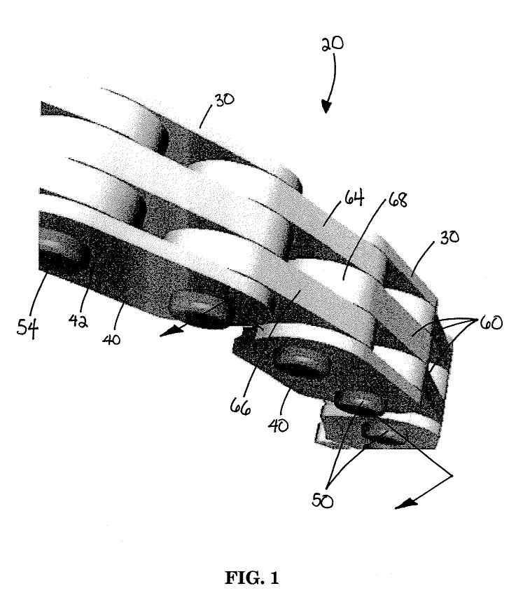

FIG. 1 shows a section of a chain 20 having first and second outer plates 30, 40 according to the present invention. The chain 20 also includes pins 50, each having a first end 52 and a second end 54. The first and second outer plates 30, 40 are press-fitted around the first and second ends 52, 54 of the pins 50, respectively. Each of the first outer plates 30 has two bores 32 through which the first ends 52 of respective ones of the pins 50 extend, and each of the second outer plates 40 has two bores 42 through which the second ends 54 of respective ones of the pins 50 extend. The chain 20 further includes inner plates 60 disposed between the first and second outer plates 30, 40, each of the inner plates 60 having two bores arranged around respective ones of the pins 50 with a slip-fit. The inner plates 60 can include first and second inner plates 64, 66 and middle plates 68 disposed between the first and second inner plates 64, 66. The first and second outer plates 30, 40 are aligned with the middles plates 68, and the first and second inner plates 64, 66 are aligned with each other and offset by one pin 50 from the middle plates 68. The bores of the first and second inner plates 64, 66 are arranged about the pins 50 with a slip-fit to form articulating surfaces for the link of the chain. The bores of the middle plates 68 can also be arranged about the pins 50 with a slip-fit to form additional articulating surfaces. Alternatively, the bores of the middle plates 68 can be press-fit around the pins 50.

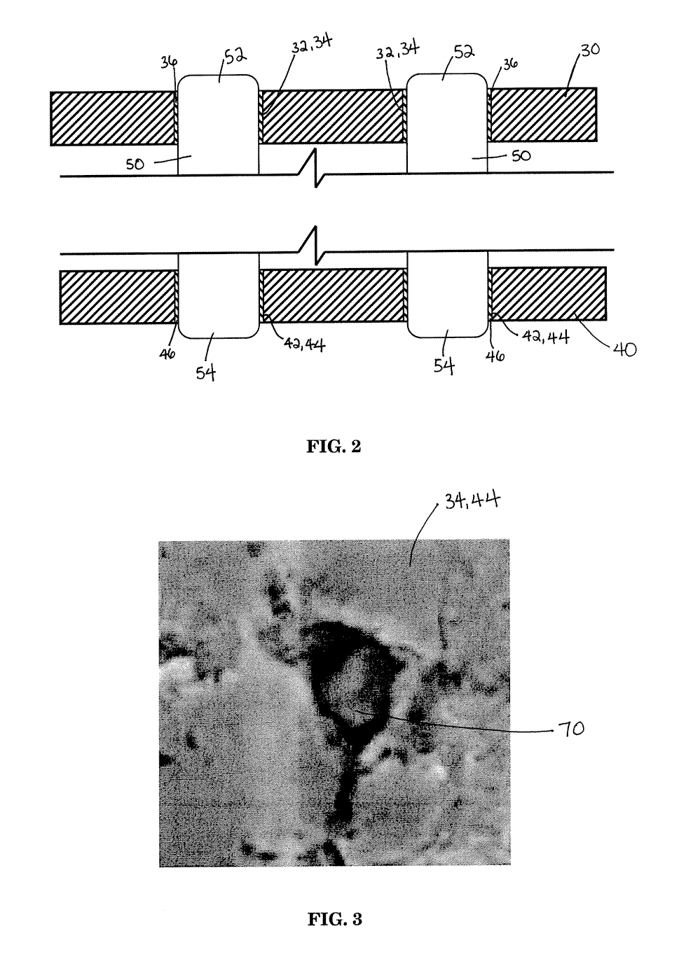

As shown in FIG. 2, each of the bores 32, 42 of the first and second outer plates 30, 40 has an inner wall 34, 44 with a layer of imbedded abrasive material 36, 46. The layer of imbedded abrasive material 36, 46 in the inner wall 34, 44 of each bore 32, 42 increases friction between the inner walls 34, 44 of the bores 32, 42 and the pins 50 press-fitted within the bores 32, 42, which in turn increases the press out force required to remove the outer plates 30, 40 from the pins 50. When the bores 32, 42 of the outer plates 30, 40 are formed through a regular blanking operation, the layers of imbedded abrasive material 36, 46 in the inner walls 34, 44 increase the load-carrying capability of the bores 32, 42 by “biting” into the outer surface of the pins 50, which counteracts the breakout area from the blanking operation. The outer plates 30, 40 according to the present invention thus allows for increased press out force without the use of expensive and time consuming methods such as shaving and fine blanking. For a given plate thickness and bore diameter, forming a layer of imbedded abrasive material in bores formed from regular blanking can increase the press out force by 30%-40%. The additional load-carrying capability of the layers of imbedded abrasive material 36, 46 also allows the outer plates 30, 40 according to the present invention to have decreased thicknesses in comparison to known outer plates. The plate thickness can be decreased by approximately 30% while maintaining the same press out force. For example, in a timing chain application for an internal combustion engine, an outer plate according to the present invention having a bore diameter of 4 mm can have a thickness of less than 1.3 mm, and as low as 0.9 mm, in comparison to the known prior art outer plates for similar applications having a thickness of 0.9 mm, which can only be achieved by fine blanking.

The layers of embedded abrasive material 36, 46 in the inner walls 34, 44 of the bores 32, 42 can be formed from any material having the suitable friction characteristics. For example and without limitation, the abrasive material can be aluminum oxide or silicon oxide, which are commonly used in steel finishing processes. As shown in FIG. 3, the particles 70 of the abrasive material are embedded in the inner walls 34, 44 of the bores 32, 42, acting as barbs that bite into the pins 50, thus increasing the press out force of the outer plates 30, 40. The outer plates 30, 40 of the present invention provide significant cost savings by eliminating the need for complicated blanking processes and a separate finishing process, as the process of embedding the abrasive material in the bores 32, 42 also serves to de-burr the outer plates 30, 40.

While the outer plates 30, 40 according to the present invention have been described in the context of a roller chain or silent chain, one of ordinarily skill in the art would appreciate that the present outer plates can be used in any chain where a large press out force is desired. For example, the present outer plates can also be used in a bushed chain, where the outer plates are press-fitted around bushings instead of pins. The layers of embedded abrasive material formed in the inner walls of the bores increases the friction between the inner walls of the bores and the outer surface of the bushings, thus maximizing the press out force between the outer plates and the bushings.

A method of forming the outer plates 30, 40 of the present invention is also disclosed, including the following steps. First, a plate is provided. The plate may be formed from any suitable material, such as steel. Two bores are formed in the plate through blanking. Preferably, a regular blanking operation is used to reduce the cost of forming the outer plate. A layer of embedded abrasive material is then formed in an inner wall of each bore by tumbling the plate with a solution containing the abrasive material and a tumbling media. The solution can be, for example and without limitation, a mixture of water and aluminum oxide, which is commonly used to finish steel. Alternatively, the solution can be a mixture of water and silicon oxide. The tumbling media can be of any material, size, or shape that is suitable for embedding the abrasive material into the inner walls of the bores, and may vary depending on the material and dimensions of the particular outer plate being formed. For example and without limitation, the tumbling media can be in the form of balls each having a diameter of approximately 2 mm-3 mm, which is suitable where the bores of the outer plate each has a diameter of approximately 4 mm. The balls can be formed from steel or glass. During the tumbling process, the tumbling media support and embed the abrasive material into the inner walls of the bores. In addition, the contact between the tumbling media, the solution containing the abrasive material, and the outer plate during tumbling de-burrs the outer plate, eliminating the need for an additional finishing process. As discussed above, the layer of imbedded abrasive material in the inner wall of each bore increases friction between the inner walls of the bores and pins arranged within the bores, which increases the press out force between the outer plate and the pins. The present method of forming an outer plate decreases the time and cost of construction as well as the required thickness of the outer plate. Given a bore diameter of approximately 4 mm, an outer plate formed by the present method can have a thickness of less than 1.3 mm, and as low as 0.9 mm.

Having thus described various embodiments of the present outer plate and resulting chain in detail, it is to be appreciated and will be apparent to those skilled in the art that many physical changes, only a few of which are exemplified in the detailed description above, could be made in the apparatus and method without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. An outer plate for a chain, the outer plate comprising two bores each adapted to receive an end of a pin, each of the bores having an inner wall with a layer of imbedded abrasive material.

2. The outer plate of claim 1, wherein the layer of imbedded abrasive material in the inner wall of each of the bores increases friction between the inner walls of the bores and pins arranged within the bores.

3. The outer plate of claim 1, wherein the abrasive material comprises aluminum oxide.

4. The outer plate of claim 1, wherein the abrasive material comprises silicon oxide.

5. The outer plate of claim 1, wherein each of the bores has a diameter of approximately 4 mm and the outer plate has a thickness of less than 1.3 mm.

6. The outer plate of claim 5, wherein the thickness of the outer plate is approximately 0.9 mm.

7. A chain comprising:
pins, each having a first end and a second end;
first and second outer plates press-fitted around the first and second ends of each of the pins, respectively, each of the first outer plates having two bores through which the first ends of respective ones of the pins extend, and each of the second outer plates having two bores through which the second ends of respective ones of the pins extend, each of the bores of the first and second outer plates having an inner wall with a layer of imbedded abrasive material; and
inner plates disposed between the first and second outer plates, each of the inner plates having two bores arranged around respective ones of the pins with a slip-fit.

8. The chain of claim 7, wherein the inner plates comprise first and second inner plates and middle plates disposed between the first and second inner plates, the first and second outer plates being aligned with the middle plates, the first and second inner plates being aligned with each other and offset by one pin from the middle plates.

9. The chain of claim 7, wherein the abrasive material comprises aluminum oxide.

10. The chain of claim 7, wherein the abrasive material comprises silicon oxide.

11. The chain of claim 7, wherein each of the first and second outer plates has a thickness of approximately 0.9 mm.

12. A method of forming an outer plate for a chain, the method comprising:
providing a plate;
forming two bores in the plate through blanking;
forming a layer of embedded abrasive material in an inner wall of each of the bores by tumbling the plate with a solution containing the abrasive material and a tumbling media.

13. The method of claim 12, wherein the tumbling media comprises steel balls.

14. The method of claim 12, wherein the tumbling media comprises glass balls.

15. The method of claim 12, wherein the tumbling media comprises balls each having a diameter of approximately 2 mm-3 mm.

16. The method of claim 12, wherein contact between the tumbling media, the solution containing the abrasive material, and the plate during tumbling de-burrs the plate.

17. The method of claim 12, wherein the plate has a thickness of less than 1.3 mm and each of the bores in the plate has a diameter of approximately 4 mm.

18. The method of claim 17, wherein the thickness of the plate is approximately 0.9 mm.

19. The method of claim 12, wherein the solution comprises water and aluminum oxide.

20. The method of claim 12, wherein the solution comprises water and silicon oxide.
